(19) United States
(12) Patent Application Publication
(10) Pub. No.: US 2026/0290635 A1
(43) Pub. Date: Sep. 24, 2026

(54) NON-INTEGRAL FEEDWATER PLENUM

(71) Applicant: NuScale Power, LLC, Corvallis, OR (US)

(72) Inventor: Todd Sorensen, St. Joseph, MI (US)

(21) Appl. No.: 19/176,996

(22) Filed: Apr. 11, 2025

Related U.S. Application Data
(60) Provisional application No. 63/644,927, filed on May 9, 2024.

(51) Int. Cl. G21C 15/12

(52) U.S. Cl. CPC G21C 15/12

(57) ABSTRACT

A system comprising a reactor pressure vessel (RPV), a plenum, having a first end and a second end, a welded seal attaching the plenum to the RPV, and a compression seal at least partially disposed within the flange. The plenum includes a flange to engage with the RPV at the first end, a conduit extending from the flange in a direction, and a tubesheet extending from the conduit at the second end opposite the first end.

### CROSS-REFERENCE TO RELATED APPLICATION(S)

This application claims the benefit of U.S. Provisional Application No. 63/644,927 filed May 9, 2024, and titled “Non-Integral Feedwater Plenum,” which is incorporated herein by reference in its entirety.

### STATEMENT REGARDING FEDERALLY SPONSORED RESEARCH

This invention was made with Government support under Contract No. DE-NE0008928 awarded by the Department of Energy. The Government has certain rights in this invention.

### BACKGROUND

Nuclear reactors utilize a feedwater plenum and tubesheet to direct a flow of feedwater into a reactor pressure vessel (RPV). Because of the geometric constraints indicative of small modular nuclear reactors (SMRs) causing an inability to access the feedwater plenum and tubesheet for visual inspection, the typical feedwater plenum design of an SMR requires the feedwater plenum and tubesheet to be integral to the RPV.

In some circumstances, the integral feedwater plenum intersects with the wall of the RPV, which may limit the material selection for the feedwater plenum and cause differential expansion (pressure and/or thermal) between the RPV and the feedwater plenum and/or the tubesheet (e.g., reactor coolant pressure boundary, etc.). An integral feedwater plenum may also cause structural integrity challenges due to temperature and pressure changes at the connection points between the feedwater plenum and the RPV. By requiring an integral feedwater plenum integral with the RPV, the typical SMR design utilizing a more flexible integral feedwater plenum is burdened by challenges associated with machinability, cladding application (e.g., in the case of carbon steel forging), and/or the accommodation of inspection criteria required.

### BRIEF DESCRIPTION OF THE DRAWINGS

FIG. 1 schematically illustrates an integrated power plant system that includes a power plant system that uses a small modular nuclear reactor (SMR) system with nuclear power modules (NPMs) that include a non-integral feedwater plenum, according to an embodiment of this disclosure.

FIG. 2 illustrates a side cross-sectional view of a non-integral feedwater plenum welded to the RPV of an NPM and with a cover plate installed, according to an embodiment of this disclosure.

FIG. 3 illustrates a detailed side cross-sectional view of a portion of the non-integral feedwater plenum of FIG. 2 welded to the RPV of an NPM and with a cover plate installed, according to an embodiment of this disclosure.

FIG. 4 illustrates a detailed side cross-sectional view of a portion of a non-integral feedwater plenum of FIG. 2 welded to the RPV and without the cover plate installed, according to an embodiment of this disclosure.

FIG. 5 illustrates an alternative isometric view depicting the side rear of a non-integral feedwater plenum installed in an NPM with a cover plate installed, according to an embodiment of this disclosure.

FIG. 6 illustrates an alternative isometric partial cross-sectional view depicting the front and side view of a non-integral feedwater plenum installed in an NPM with a cover plate installed, according to an embodiment of this disclosure.

FIG. 7 is a partially schematic, partially cross-sectional view of a nuclear reactor system configured in accordance with embodiments of the present technology.

FIG. 8 is a partial schematic, partial cross-sectional view of a nuclear reactor system configured in accordance with additional embodiments of the present technology.

FIG. 9 is a schematic view of a nuclear power plant system including multiple nuclear reactors in accordance with embodiments of the present technology.

### DETAILED DESCRIPTION

### Overview

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

Specific details of one or more embodiments of the present technology are described herein. The present technology, however, may be practiced without some of these specific details. In some instances, well-known structures and techniques often associated with steam generation, nuclear power conversion systems, and the like have not been shown in detail so as not to obscure the present technology.

The terminology used in the description presented below is intended to be interpreted in its broadest reasonable manner, even though it is being used in conjunction with a detailed description of certain specific embodiments of the disclosure. Certain terms may even be emphasized below; however, any terminology intended to be interpreted in any restricted manner will be overtly and specifically defined as such in this Detailed Description section.

The headings provided herein are for convenience only and should not be construed as limiting the subject matter disclosed.

This disclosure is directed to a non-integral feedwater plenum for use in nuclear reactors (e.g., small modular nuclear reactors (SMRs), pressurized water reactors, advanced reactors, etc.). While specifically, discussed as being useful for nuclear reactors, the non-integral plenum may be useful in other applications for other systems.

### Illustrative Embodiments

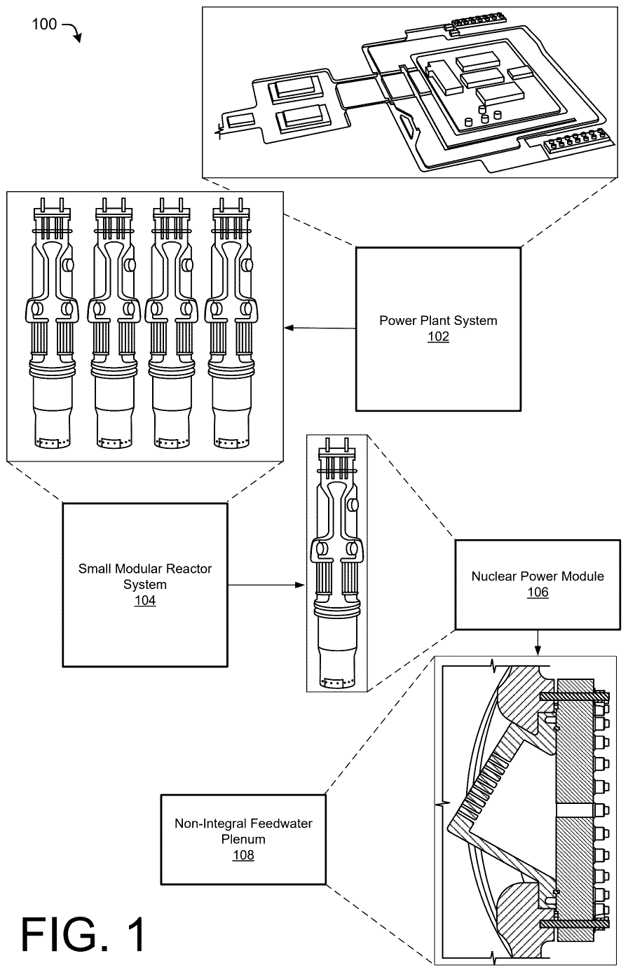

FIG. 1 schematically illustrates an integrated power plant system 100 that includes a power plant system 102 that uses a small modular nuclear reactor (SMR) system 104 with one or more nuclear power modules (NPMs) 106 that include a non-integral feedwater plenum 108 (“feedwater plenum”), according to an embodiment of this disclosure.

In an embodiment, the SMR system 104 may include a multi-module power plant design with similar NPMs. In an embodiment, the SMR system 104 may represent any type of power plant system (e.g., advanced nuclear reactor system, microreactor system, pressurized heavy water nuclear reactor system, etc.). For example, the power plant system 102 may include multiple SMRs with the same or different sizes and/or operating characteristics.

In an embodiment, the feedwater plenum 108 may be installed in one or more NPMs 106. For example, the feedwater plenum 108 may be installed in a reactor pressure vessel (RPV) of one or more of the NPMs 106.

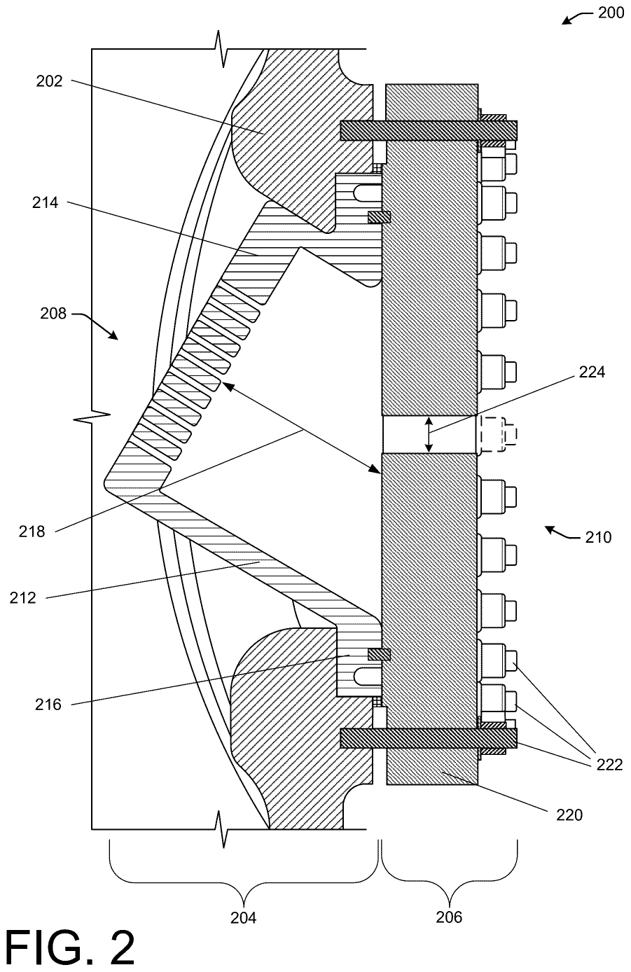

FIG. 2 illustrates a side cross-sectional view of a non-integral feedwater plenum 200 (“plenum 200”) welded to the RPV 202 of an NPM and with a cover plate 220 installed.

In an embodiment, the plenum 200 may include an internal portion 204 and an external portion 206. The plenum 200 may have a first end 208 (e.g., front end, inner end, etc.) a second end 210 (e.g., rear end, outer end, etc.).

In an embodiment, the internal portion 204 may include a conduit 212 (e.g., cylinder, etc.) extending from a tubesheet 214 at the first end 208 of the conduit 212 to a flange 216 at the second end 210 of the conduit 212. The external portion 206 may include the flange 216. The conduit 212 may be fluidly connected to the tubesheet and/or to the flange 216. The conduit 212 may extend from the flange 216 at a non-perpendicular angle, relative to the flange 216, in a direction (e.g., a first direction) toward the tubesheet 214. At the time of manufacture of the plenum 200, the internal portion 204 may extend from the flange 216 at any desired angle.

For example, a first plenum 200 may be manufactured specifically to be installed in a first NPM having specific dimensions that may require the internal portion 204 to extend from the external portion 206 at a first angle relative to the external portion 206 in order for the tubesheet 214 to accommodate a first steam generator tubesheet (not shown) in the first NPM. Continuing the example, a second plenum 200 may be manufactured specifically to be installed in a second NPM having specific dimensions that may require the internal portion 204 to extend from the external portion 206 at a second angle relative to the external portion 206 that is different than the first angle in order for the tubesheet 214 to accommodate a second steam generator tubesheet (not shown) in the second NPM.

In an embodiment, the conduit 212 may extend from the flange 216 to the tubesheet 214 at a length 218 (e.g., first length, etc.). At the time of manufacture, the length 218 of the conduit 212 and/or the non-perpendicular angle of the conduit 212 relative to the flange 216 may be determined. For example, the length 218 may be increased or reduced and/or the non-perpendicular angle of the conduit 212 relative to the flange 216 may be increased or reduced.

In an embodiment, the external portion of the plenum 200 may include a cover plate 220 and one or more fasteners 222 (e.g., studs and nuts, bolts, or any other suitable fattener). The cover plate 220 may be coupled to the RPV 202 via the one or more fasteners 222. In an embodiment, the cover plate 220 may include an aperture 224 (e.g., inlet, feedwater inlet, etc.) extending through the cover plate 220.

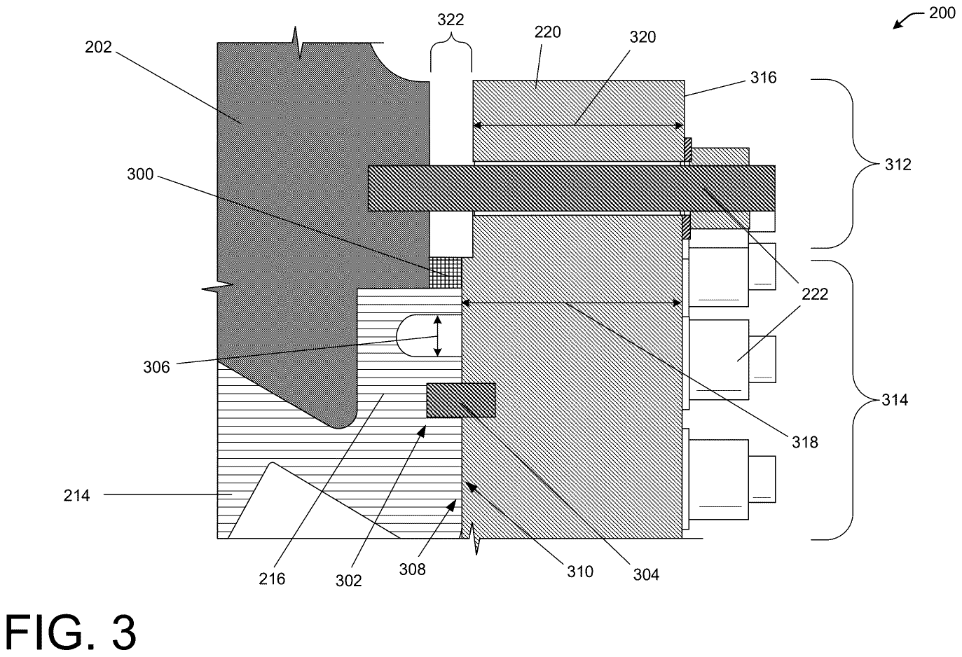

FIG. 3 illustrates a detailed side cross-sectional view of a portion of the non-integral feedwater plenum 200 of FIG. 2 welded to the RPV 202 of an NPM and with a cover plate 220 installed.

In an embodiment, the plenum 200 may include a welded seal 300, a compression seal channel 302 (the compression seal channel 302 is not visible as a portion of a compression seal 304 is shown disposed therein), the compression seal 304 (e.g., O-ring, etc.), an expansion channel 306, and a sealing surface 308 (e.g., flange sealing surface, first sealing surface, etc.).

The welded seal 300 may be a steel alloy (e.g., high-strength low-alloy steel, stainless steel, etc.) or any other suitable material. The welded seal 300 may be used to attach the plenum 200 to the RPV 202. The welded seal 300 may extend around a portion of the outside perimeter of the flange 216 that extends beyond the RPV. In an embodiment, the welded seal 300 may be a single continuous line. In an embodiment, the welded seal 300 may include multiple segments.

The compression seal channel 302 may continuously extend around the flange sealing surface 308 (i.e., the compression seal channel 302 may form a circle adjacent the expansion channel 306). In an embodiment, a portion of the compression seal 304 (e.g., first portion, etc.) may be disposed within the compression seal channel 302, and a second portion of the compression seal 304 may protrude from the compression seal channel 302. In an embodiment, the compression seal 304 may be removed from the compression seal channel 302 and/or replaced.

In an embodiment the flange sealing surface 308 may be configured to planarly engage with a sealing surface 310 (e.g., cover plate sealing surface, second sealing surface, etc.). As the cover plate sealing surface 310 moves closer to the flange sealing surface 308, the compression seal 304 (when installed) may be compressed to limit fluid flow between the flange sealing surface 308 and the cover plate sealing surface 310. In an embodiment, the compression seal 304 may be made of nitrile, silicone, reinforced silicone, or any other suitable material.

In an embodiment, the expansion channel 306 may continuously extend around the flange sealing surface 308 (i.e., the expansion channel 306 may form a circle adjacent an outer edge portion of the flange sealing surface 308). The expansion channel 306 may extend in a direction away from the flange sealing surface 308. Additionally, at the time of manufacture, the expansion channel 306 may be configured to have a width, as required.

In an embodiment, the cover plate 220 may include an outer region 312 (e.g., first region, fastener region, fastener region, outer portion, first/second portion, etc.) and an inner region 314 (e.g., second region, an outside region, sealing region, inner portion, first/second portion, etc.). The cover plate 220 may include an outside surface 316 configured to engage with the one or more fasteners 222. In an embodiment the inner region 314 may extend from the cover plate sealing surface 310 to the outside surface 316 at a width 318. In an embodiment, the outer region 312 may extend at a width 320, which is less that the width 318. When the cover plate 220 is installed, a gap 322 may exist between the outer region 312 of the cover plate 220 and the RPV 202.

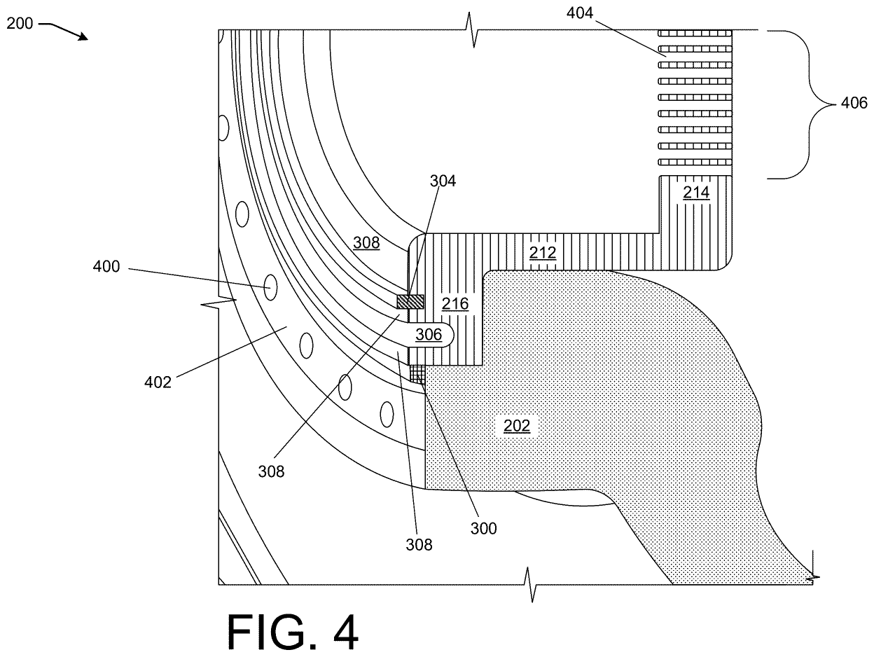

FIG. 4 illustrates a detailed side cross-sectional view of a portion of a non-integral feedwater plenum 200 of FIG. 2 welded to the RPV 202 and without the cover plate 220 installed. When the cover plate 220 is removed, the weld seal 300 and the compression seal 304 may be accessible for inspection.

In an embodiment, the RPV 202 may include one or more apertures 400 (e.g., bolt hole(s), stud hole(s), threaded hole(s), etc.) and a surface 402 (e.g., mounting surface, bolt surface, stud surface, fastening surface, etc.). In an embodiment, the one or more apertures 400 may be configured to receive the one or more fasteners 222.

In an embodiment, the one or more fasteners 222 may be threaded fasteners (e.g., bolts) and the one or more apertures 400 may be threaded and configured to receive the threaded portion of the threaded fasteners. In an embodiment, the one or more fasteners 222 may include studs and nuts and the apertures 400 may be configured to receive a first end of the studs and the second end of the studs may be configured to receive the nut. In an embodiment wherein the one or more fasteners 222 may include studs and nuts, the studs may be disposed within the apertures 400 such that the studs may be secured in a fixed position (e.g., pressed fit, threaded, etc.).

In an embodiment, the tubesheet 214 may include a plurality of apertures 406 extending therethrough. In an embodiment, the plurality of apertures may include one or more individual apertures 404 extending through the tubesheet 214. In an embodiment, the individual aperture 404 may be configured to accommodate a tube (not shown) to be disposed therethrough. In an embodiment, a first end of the individual aperture 404 may be configured to engage with a first tube (not shown) and/or a second end of the individual aperture 404 opposite the first end may be configured to engage with a second tube (not shown).

In an embodiment, the plurality of apertures 406 may include one or more individual apertures 404 wherein at least one of the individual apertures 404 is configured to accommodate a tube (not shown) extending therethrough. In an embodiment, the plurality of apertures 406 may include one or more apertures 404 configured to engage with a first tube (not shown) and/or a second end of the individual aperture 404 opposite the first end may be configured to engage with a second tube (not shown).

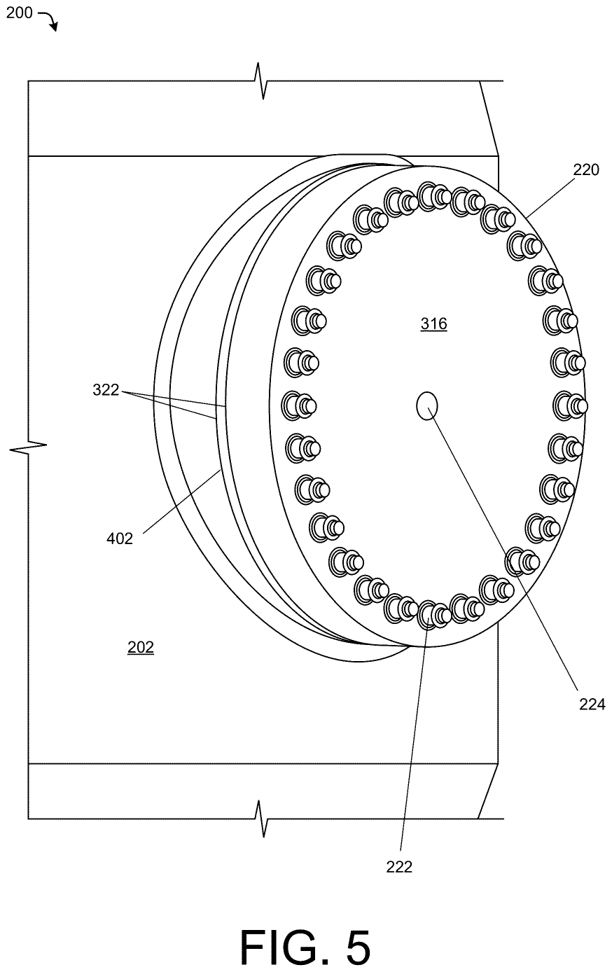

FIG. 5 illustrates an alternative isometric view depicting the side rear of a non-integral feedwater plenum 200 fully installed in an NPM with the cover plate 220 installed.

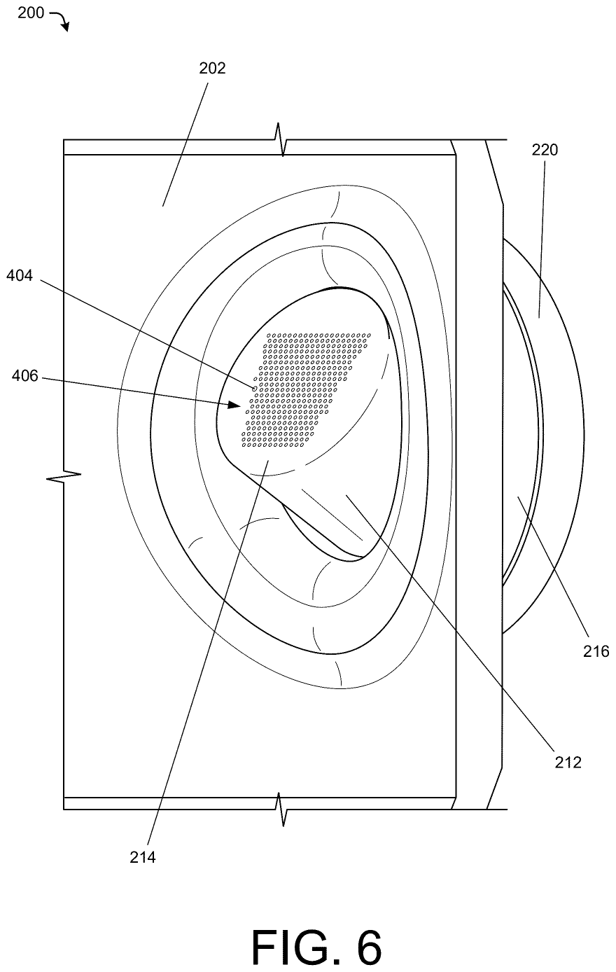

FIG. 6 illustrates an alternative isometric partial cross-sectional view depicting the front and side view of a non-integral feedwater plenum 200 installed in an NPM with the cover plate 220 installed.

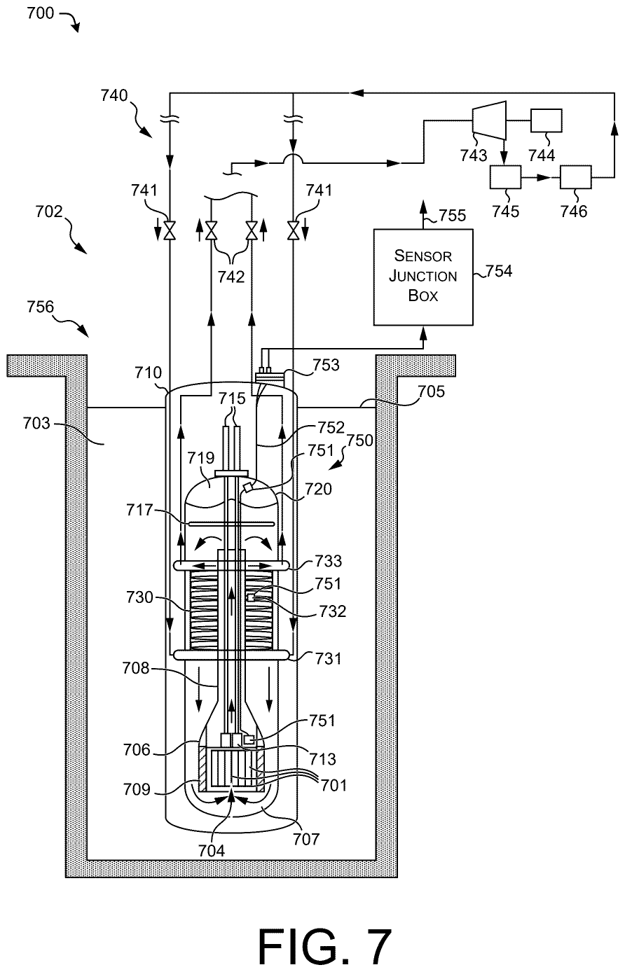

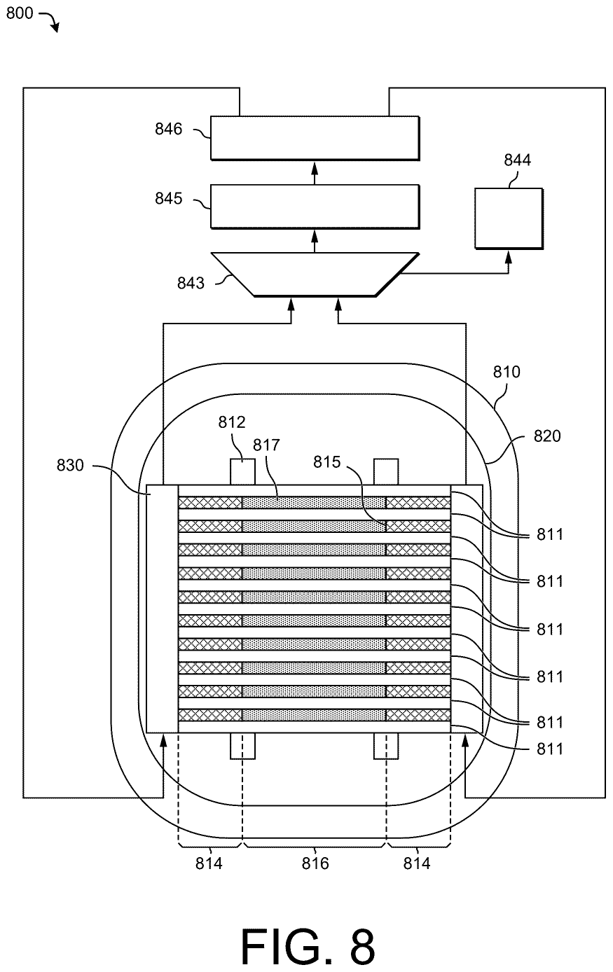

FIGS. 7 and 8 illustrate representative nuclear reactors that may be included in embodiments of the present technology. FIG. 7 is a partially schematic, partially cross-sectional view of a nuclear reactor system 700 configured in accordance with embodiments of the present technology. The system 700 can include a power module 702 having a reactor core 704 in which a controlled nuclear reaction takes place. Accordingly, the reactor core 704 can include one or more fuel assemblies 701. The fuel assemblies 701 can include fissile and/or other suitable materials. Heat from the reaction generates steam at a steam generator 730, which directs the steam to a power conversion system 740. The power conversion system 740 generates electrical power, and/or provides other useful outputs, such as super-heated steam. A sensor system 750 is used to monitor the operation of the power module 702 and/or other system components. The data obtained from the sensor system 750 can be used in real time to control the power module 702, and/or can be used to update the design of the power module 702 and/or other system components.

The power module 702 includes a containment vessel 710 (e.g., a radiation shield vessel, or a radiation shield container) that houses/encloses a reactor vessel 720 (e.g., a reactor pressure vessel, or a reactor pressure container), which in tum houses the reactor core 704. The containment vessel 710 can be housed in a power module bay 756. The power module bay 756 can contain a cooling pool 703 filled with water and/or another suitable cooling liquid. The bulk of the power module 702 can be positioned below a surface 705 of the cooling pool 703. Accordingly, the cooling pool 703 can operate as a thermal sink, for example, in the event of a system malfunction.

A volume between the reactor vessel 720 and the containment vessel 710 can be partially or completely evacuated to reduce heat transfer from the reactor vessel 720 to the surrounding environment (e.g., to the cooling pool 703). However, in other embodiments the volume between the reactor vessel 720 and the containment vessel 710 can be at least partially filled with a gas and/or a liquid that increases heat transfer between the reactor vessel 720 and the containment vessel 710. For example, the volume between the reactor vessel 720 and the containment vessel 710 can be at least partially filled (e.g., flooded with the primary coolant 707) during an emergency operation.

Within the reactor vessel 720, a primary coolant 707 conveys heat from the reactor core 704 to the steam generator 730. For example, as illustrated by arrows located within the reactor vessel 720, the primary coolant 707 is heated at the reactor core 704 toward the bottom of the reactor vessel 720. The heated primary coolant 707 (e.g., water with or without additives) rises from the reactor core 704 through a core shroud 706 and to a riser tube 708. The hot, buoyant primary coolant 707 continues to rise through the riser tube 708, then exits the riser tube 708 and passes downwardly through the steam generator 730. The steam generator 730 includes a multitude of conduits 732 that are arranged circumferentially around the riser tube 708, for example, in a helical pattern, as is shown schematically in FIG. 7. The descending primary coolant 707 transfers heat to a secondary coolant (e.g., water) within the conduits 732, and descends to the bottom of the reactor vessel 720 where the cycle begins again. The cycle can be driven by the changes in the buoyancy of the primary coolant 707, thus reducing or eliminating the need for pumps to move the primary coolant 707.

The steam generator 730 can include a feedwater header 731 at which the incoming secondary coolant enters the steam generator conduits 732. The secondary coolant rises through the conduits 732, converts to vapor (e.g., steam), and is collected at a steam header 733. The steam exits the steam header 733 and is directed to the power conversion system 740.

The power conversion system 740 can include one or more steam valves 742 that regulate the passage of high pressure, high temperature steam from the steam generator 730 to a steam turbine 743. The steam turbine 743 converts the thermal energy of the steam to electricity via a generator 744. The low-pressure steam exiting the turbine 743 is condensed at a condenser 745, and then directed (e.g., via a pump 746) to one or more feedwater valves 741. The feedwater valves 741 control the rate at which the feedwater re-enters the steam generator 730 via the feedwater header 731. In other embodiments, the steam from the steam generator 730 can be routed for direct use in an industrial process, such as a Hydrogen (H₂) and Oxygen (O₂) production plant, a chemical production plant, and/or the like, as described in detail below. Accordingly, steam exiting the steam generator 730 can bypass the power conversion system 740.

The power module 702 includes multiple control systems and associated sensors. For example, the power module 702 can include a hollow cylindrical reflector 709 that directs neutrons back into the reactor core 704 to further the nuclear reaction taking place therein. Control rods 713 are used to modulate the nuclear reaction and are driven via fuel rod drivers 715. The pressure within the reactor vessel 720 can be controlled via a pressurizer plate 717 (which can also serve to direct the primary coolant 707 downwardly through the steam generator 730) by controlling the pressure in a pressurizing volume 719 positioned above the pressurizer plate 717.

The sensor system 750 can include one or more sensors 751 positioned at a variety of locations within the power module 702 and/or elsewhere, for example, to identify operating parameter values and/or changes in parameter values. The data collected by the sensor system 750 can then be used to control the operation of the system 700, and/or to generate design changes for the system 700. For sensors positioned within the containment vessel 710, a sensor link 752 directs data from the sensors to a flange 753 (at which the sensor link 752 exits the containment vessel 710) and directs data to a sensor junction box 754. From there, the sensor data can be routed to one or more controllers and/or other data systems via a data bus 755.

FIG. 8 is a partially schematic, partially cross-sectional view of a nuclear reactor system 800 configured in accordance with additional embodiments of the present technology. In some embodiments, the nuclear reactor system 800 (“system 800”) can include some features that are at least generally similar in structure and function, or identical in structure and function, to the corresponding features of the system 700 described in detail above with reference to FIG. 7 and can operate in a generally similar or identical manner to the system 700.

In the illustrated embodiment, the system 800 includes a reactor vessel 820 and a containment vessel 810 surrounding/enclosing the reactor vessel 820. In some embodiments, the reactor vessel 820 and the containment vessel 810 can be roughly cylinder-shaped or capsule-shaped. The system 800 further includes a plurality of heat pipe layers 811 within the reactor vessel 820. In the illustrated embodiment, the heat pipe layers 811 are spaced apart from and stacked over one another. In some embodiments, the heat pipe layers 811 can be mounted/secured to a common frame 812, a portion of the reactor vessel 820 (e.g., a wall thereof), and/or other suitable structures within the reactor vessel 820. In other embodiments, the heat pipe layers 811 can be directly stacked on top of one another such that each of the heat pipe layers 811 supports and/or is supported by one or more of the other ones of the heat pipe layers 811.

In the illustrated embodiment, the system 800 further includes a shield or reflector region 814 at least partially surrounding a core region 816. The heat pipe layers 811 can be circular, rectilinear, polygonal, and/or can have other shapes, such that the core region 816 has a corresponding three-dimensional shape (e.g., cylindrical, spherical). In some embodiments, the core region 816 is separated from the reflector region 814 by a core barrier 815, such as a metal wall. The core region 816 can include one or more fuel sources, such as fissile material, for heating the heat pipe layers 811. The reflector region 814 can include one or more materials configured to contain/reflect products generated by burning the fuel in the core region 816 during operation of the system 800. For example, the reflector region 814 can include a liquid or solid material configured to reflect neutrons and/or other fission products radially inward toward the core region 816. In some embodiments, the reflector region 814 can entirely surround the core region 816. In other embodiments, the reflector region 814 may partially surround the core region 816. In some embodiments, the core region 816 can include a control material 817, such as a moderator and/or coolant. The control material 817 can at least partially surround the heat pipe layers 811 in the core region 816 and can transfer heat therebetween.

In the illustrated embodiment, the system 800 further includes at least one heat exchanger 830 (e.g., a steam generator) positioned around the heat pipe layers 811. The heat pipe layers 811 can extend from the core region 816 and at least partially into the reflector region 814 and are thermally coupled to the heat exchanger 830. In some embodiments, the heat exchanger 830 can be positioned outside of or partially within the reflector region 814. The heat pipe layers 811 provide a heat transfer path from the core region 816 to the heat exchanger 830. For example, the heat pipe layers 811 can each include an array of heat pipes that provide a heat transfer path from the core region 816 to the heat exchanger 830. When the system 800 operates, the fuel in the core region 816 can heat and vaporize a fluid within the heat pipes in the heat pipe layers 811, and the fluid can carry the heat to the heat exchanger 830. The heat pipes in the heat pipe layers 811 can then return the fluid toward the core region 816 via wicking, gravity, and/or other means to be heated and vaporized once again.

In some embodiments, the heat exchanger 830 can be similar to the steam generator 730 of FIG. 7 and, for example, can include one or more helically-coiled tubes that wrap around the heat pipe layers 811. The tubes of the heat exchanger 830 can include or carry a working fluid (e.g., a coolant such as water or another fluid) that carries the heat from the heat pipe layers 811 out of the reactor vessel 820 and the containment vessel 810 for use in generating electricity, steam, and/or the like. For example, in the illustrated embodiment the heat exchanger 830 is operably coupled to a turbine 843, a generator 844, a condenser 845, and a pump 846. As the working fluid within the heat exchanger 830 increases in temperature, the working fluid may begin to boil and vaporize. The vaporized working fluid (e.g., steam) may be used to drive the turbine 843 to convert the thermal potential energy of the working fluid into electrical energy via the generator 844. The condenser 845 can condense the working fluid after it passes through the turbine 843, and the pump 846 can direct the working fluid back to the heat exchanger 830 where it can begin another thermal cycle. In other embodiments, steam from the heat exchanger 830 can be routed for direct use in an industrial process, such as an enhanced oil recovery operation described in detail below. Accordingly, steam exiting the heat exchanger 830 can bypass the turbine 843, the generator 844, the condenser 845, the pump 846, etc.

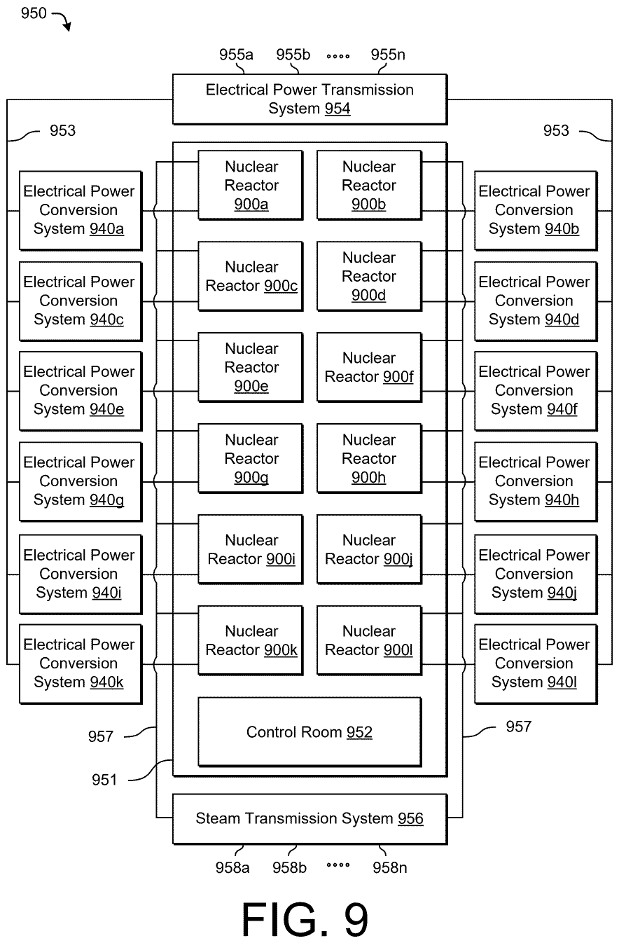

FIG. 9 is a schematic view of a nuclear power plant system 950 including multiple nuclear reactors 900 in accordance with embodiments of the present technology. Each of the nuclear reactors 900 (individually identified as first through twelfth nuclear reactors 900a-l, respectively) can be similar to or identical to the nuclear reactor 900 and/or the nuclear reactor 900 described in detail above with reference to FIGS. 7 and 8. The power plant system 950 (“power plant system 950”) can be “modular” in that each of the nuclear reactors 900 can be operated separately to provide an output, such as electricity or steam. The power plant system 950 can include fewer than twelve of the nuclear reactors 900 (e.g., two, three, four, five, six, seven, eight, nine, ten, or eleven of the nuclear reactors 900), or more than twelve of the nuclear reactors 900. The power plant system 950 can be a permanent installation or can be mobile (e.g., mounted on a truck, tractor, mobile platform, and/or the like). In the illustrated embodiment, each of the nuclear reactors 900 can be positioned within a common housing 951, such as a reactor plant building, and controlled and/or monitored via a control room 952.

Each of the nuclear reactors 900 can be coupled to a corresponding electrical power conversion system 940 (individually identified as first through twelfth electrical power conversion systems 940a-l, respectively). The electrical power conversion systems 940 can include one or more devices that generate electrical power or some other form of usable power from steam generated by the nuclear reactors 900. In some embodiments, multiple ones of the nuclear reactors 900 can be coupled to the same one of the electrical power conversion systems 940 and/or one or more of the nuclear reactors 900 can be coupled to multiple ones of the electrical power conversion systems 940 such that there is not a one-to-one correspondence between the nuclear reactors 900 and the electrical power conversion systems 940.

The electrical power conversion systems 940 can be further coupled to an electrical power transmission system 954 via, for example, an electrical power bus 953. The electrical power transmission system 954 and/or the electrical power bus 953 can include one or more transmission lines, transformers, and/or the like for regulating the current, voltage, and/or other characteristic(s) of the electricity generated by the electrical power conversion systems 940. The electrical power transmission system 454 can route electricity via a plurality of electrical output paths 955 (individually identified as electrical output paths 955a-n) to one or more end users and/or end uses, such as different electrical loads of an integrated energy system.

Each of the nuclear reactors 900 can further be coupled to a steam transmission system 956 via, for example, a steam bus 957. The steam bus 957 can route steam generated from the nuclear reactors 900 to the steam transmission system 956 which in tum can route the steam via a plurality of steam output paths 958 (individually identified as steam output paths 958a-n) to one or more end users and/or end uses, such as different steam inputs of an integrated energy system.

In some embodiments, the nuclear reactors 900 can be individually controlled (e.g., via the control room 952) to provide steam to the steam transmission system 956 and/or steam to the corresponding one of the electrical power conversion systems 940 to provide electricity to the electrical power transmission system 954. In some embodiments, the nuclear reactors 900 are configured to provide steam either to the steam bus 957 or to the corresponding one of the electrical power conversion systems 940 and can be rapidly and efficiently switched between providing steam to either. Accordingly, in some aspects of the present technology the nuclear reactors 900 can be modularly and flexibly controlled such that the power plant system 950 can provide differing levels/amounts of electricity via the electrical power transmission system 954 and/or steam via the steam transmission system 956. For example, where the power plant system 950 is used to provide electricity and steam to one or more industrial process-such as various components of the integrated energy systems, the nuclear reactors 900 can be controlled to meet the differing electricity and steam requirements of the industrial processes.

As one example, during a first operational state of an integrated energy system employing the power plant system 950, a first subset of the nuclear reactors 900 (e.g., the first through sixth nuclear reactors 900a-f) can be configured to provide steam to the steam transmission system 956 for use in the first operational state of the integrated energy system, while a second subset of the nuclear reactors 900 (e.g., the seventh through twelfth nuclear reactors 900g-l) can be configured to provide steam to the corresponding ones of the electrical power conversion systems 940 (e.g., the seventh through twelfth electrical power conversion systems 940g-l) to generate electricity for the first operational state of the integrated energy system. Then, during a second operational state of the integrated energy system when a different (e.g., greater or lesser) amount of steam and/or electricity is required, some or all the first subset of the nuclear reactors 900 can be switched to provide steam to the corresponding ones of the electrical power conversion systems 940 (e.g., the seventh through twelfth electrical power conversion systems 940g-l) and/or some or all of the second subset of the nuclear reactors 900 can be switched to provide steam to the steam transmission system 956 to vary the amount of steam and electricity produced to match the requirements/demands of the second operational state. Other variations of steam and electricity generation are possible based on the needs of the integrated energy system. That is, the nuclear reactors 900 can be dynamically/flexibly controlled during other operational states of an integrated energy system to meet the steam and electricity requirements of the operational state.

In contrast, some conventional nuclear power plant systems can typically generate either steam or electricity for output and cannot be modularly controlled to provide varying levels of steam and electricity for output. Moreover, it is typically difficult (e.g., expensive, time consuming, etc.) to switch between steam generation and electricity generation in conventional nuclear power plant systems. Specifically, for example, it is typically extremely time consuming to switch between steam generation and electricity generation in prototypical large nuclear power plant systems.

The nuclear reactors 900 can be individually controlled via one or more operators and/or via a computer system. Accordingly, many embodiments of the technology described herein may take the form of computer- or machine- or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured, or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

### Conclusion

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

The above detailed description of embodiments of the present technology are not intended to be exhaustive or to limit the technology to the precise forms disclosed above. Although specific embodiments of, and examples for, the technology are described above for illustrative purposes, various equivalent modifications are possible within the scope of the technology, as those skilled in the relevant art will recognize. For example, although steps may be presented in a given order, in other embodiments, the steps may be performed in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A system comprising:
a reactor pressure vessel (RPV);
a flange attached to the RPV;
a welded seal connecting the flange to the RPV;
a compression seal at least partially disposed within the flange; and
a cover plate including:
a first portion engaged with the flange, and
a second portion engaged with the RPV via one or more fasteners.

2. The system of claim 1, the cover plate including:
an aperture disposed through the cover plate, wherein:
the first portion extends from the aperture in a direction toward an outer perimeter of the cover plate, and
the second portion extends from the first portion in the direction, the second portion circumferentially disposed adjacent to the outer perimeter of the cover plate.

3. The system of claim 2, wherein individual ones of the one or more fasteners include a bolt.

4. The system of claim 2, wherein individual ones of the one or more fasteners include:
a stud having a first side coupled to the RPV, and
a nut configured to engage with a second side of the stud.

5. The system of claim 1, further comprising a conduit extending from the flange at a non-perpendicular angle.

6. The system of claim 5, further comprising a tubesheet extending from the conduit, the tubesheet including a plurality of apertures disposed therethrough.

7. The system of claim 1, wherein the flange includes a channel circumferentially disposed within the flange adjacent to an edge portion of the flange.

8. The system of claim 7, wherein the flange further includes a second channel to receive a portion of the compression seal at least partially disposed within the flange.

9. An apparatus comprising,
a plenum disposed in a reactor pressure vessel (RPV), the plenum having a first end and a second end, the plenum including:
a flange at the first end of the plenum to engage with the RPV,
a conduit fluidly connected to the flange at the first end of the plenum, and
a tubesheet fluidly connected to the conduit at the second end of plenum, and;
a welded seal to attach the plenum to the RPV, the welded seal circumferentially disposed around an outside perimeter of the flange; and
a compression seal at least partially disposed within the flange.

10. The apparatus of claim 9, further comprising a cover plate to engage with the plenum and the RPV, the cover plate having:
a first portion to engage with the flange via one or more fasteners circumferentially disposed adjacent an outer perimeter of the cover plate, and
a second portion to engage with the flange and the compression seal.

11. The apparatus of claim 9, wherein the flange includes a channel circumferentially disposed within the flange adjacent to an edge portion of the flange.

12. The apparatus of claim 10, wherein the flange further includes a second channel to receive the compression seal circumferentially disposed within the flange adjacent to channel.

13. The apparatus of claim 9, wherein the conduit extends from the flange toward the tubesheet in a non-perpendicular direction relative to the flange.

14. The apparatus of claim 9, the tubesheet including a plurality of apertures disposed through the tubesheet, wherein at least one aperture of the plurality of apertures is configured to accommodate a tube extending therethrough.

15. An apparatus comprising:
a plenum having a first end and a second end, wherein the first end of the plenum is at least partially disposed within a reactor pressure vessel (RPV);
a welded seal attached to the second end of the plenum and the RPV, the welded seal circumferentially disposed around an outside perimeter of the plenum at the second end of the plenum;
a compression seal at least partially disposed within the second end of the plenum; and
a cover plate to couple with the RPV via a plurality of fasteners.

16. The apparatus of claim 15, the cover plate including:
an aperture disposed through the cover plate,
a first portion extending from the aperture in a second direction toward an outer perimeter of the cover plate, and
a second portion extending from the first portion in the second direction, the second portion circumferentially disposed adjacent to the outer perimeter of the cover plate.

17. The apparatus of claim 15, the plenum including:
a tubesheet at the first end of the plenum;
a conduit extending from the tubesheet in a direction; and
a flange at the second end of the plenum, the flange configured to engage with the RPV.

18. The apparatus of claim 17, wherein the flange includes:
a first side engaged with the RPV;
a second side opposite the first side to engage with the cover plate; and
a channel circumferentially disposed within the second side of the flange.

19. The apparatus of claim 18, wherein the flange further includes a second channel to receive the compression seal circumferentially disposed within the flange adjacent to the channel.

20. The apparatus of claim 15, wherein individual ones of the plurality of fasteners include:
a stud having a first side coupled to the RPV, and
a nut configured to engage with a second side of the stud.
